(19) United States
(12) Patent Application Publication
(10) Pub. No.: US 2009/0051236 A1
(43) Pub. Date: Feb. 26, 2009

(54) DC motor, brush holder for DC motor, and system including DC motor

(76) Inventor: Harald Klode, Centerville, OH (US)

Correspondence Address: DELPHI TECHNOLOGIES, INC., M/C 480-410-202, PO BOX 5052, TROY, MI, 48007, US

(21) Appl. No.: 11/895,549

(22) Filed: Aug. 24, 2007

(51) Int. Cl. H01R 39/38; H02K 3/20; H02K 5/14; H02K 5/16

(52) U.S. Cl. 310/89; 310/198; 310/239

(57) ABSTRACT

A brush holder for a motor includes two elongated electrical conductors and a flexible, electrically-insulative brush-holder body which separately surrounds, and is strip-molded to, the conductors and which has a distal end portion including brush recesses. A motor is described which includes two support bearings axially located to one side of an armature core and a commutator and a brush holder axially located to the other side of the armature core wherein an armature winding includes a first portion at least partially axially overlapping a support bearing and a second portion at least partially axially overlapping the commutator and the brush holder. A motor system is described which includes a motor and an assembly having a component operatively driven by the motor wherein two support bearings are located to one side of an armature core, one attached to a motor end plate and one attached to an assembly housing.

### TECHNICAL FIELD

The present invention relates generally to motors, and more particularly to a DC (direct current) motor, to a brush holder for a DC motor, and to a system including a DC motor and including an assembly having a component operatively driven by the motor.

### BACKGROUND OF THE INVENTION

Conventional DC motors include a DC motor having a rotatable armature shaft. The motor includes an armature core which is attached to the armature shaft and which is surrounded by non-rotating permanent magnets attached to a motor housing. An armature winding is attached to, and axially extends beyond, the armature core. The armature winding is connected to a commutator which rotates with the armature shaft. Non-rotating brushes are connected to a DC power source and make contact with the commutator which causes the armature shaft to rotate as is known to those skilled in the art. Designs are known which have two motor-shaft support bearings located on the same side of the armature core. Other designs are known wherein radially outwardly extending brushes contact radially inwardly extending surfaces of a commutator which is attached to an overhanging portion of the armature core. Brush holders are known which include a metallic brush holder body located in an electrically-insulated portion of the motor housing.

What is needed is an improved DC motor, an improved brush holder for a DC motor, and an improved system including a DC motor and including an assembly having a component operatively driven by the motor.

### SUMMARY OF THE INVENTION

A first expression of an embodiment of the invention is for a brush holder for a DC motor wherein the brush holder includes flexible first and second elongated electrical conductors and includes an elongated, flexible, electrically-insulative brush-holder body. The first and second elongated electrical conductors each have a proximal end and a distal end. The brush-holder body: separately surrounds, and is strip-molded to, the first and second elongated electrical conductors; extends from at least proximate the proximal end to past the distal end of each of the first and second elongated electrical conductors; and has a distal end portion which surrounds the distal ends of the first and second elongated electrical conductors and which includes first and second brush recesses.

A second expression of an embodiment of the invention is for a DC motor including a rotatable armature shaft, an armature core, an armature winding, first and second support bearings, and a commutator and a brush holder. The armature shaft has a central longitudinal axis. The armature core has a first core portion attached to the armature shaft and has a second core portion which is attached to the first core portion, which extends axially from the first core portion, and which is spaced radially outwardly apart from the armature shaft. The armature winding is attached to the first and second core portions, has a first winding portion extending axially beyond the first core portion, and has a second winding portion extending axially beyond the second core portion. The first and second support bearings are operatively connected to the armature shaft, wherein the second support bearing is disposed between the first support bearing and the first core portion and wherein the first winding portion at least partially axially overlaps the second bearing. The second winding portion at least partially axially overlaps the commutator and the brush holder.

A third expression of an embodiment of the invention is for a motor system including a DC motor and an assembly. The DC motor includes: a motor housing; a rotatable armature shaft; an armature core attached to the armature shaft and disposed within the motor housing; a motor end plate having a central opening and covering the motor housing, wherein the armature shaft extends from the central opening; and a motor-associated support bearing operatively attached to the motor end plate and to the armature shaft. The assembly includes: a component operatively driven by the motor; an assembly housing; and an assembly-associated support bearing operatively attached to the assembly housing and to the armature shaft.

Several benefits and advantages are derived from one or more of the expressions of an embodiment of the invention. In one example, the strip-molded brush holder avoids the manufacturing complexities of conventional metallic brush holders. In the same or a different example, having the second winding portion at least partially axially overlap the commutator and the brush holder and having the two support bearings located on the other side of the armature core shortens the axial length of the DC motor (the combined axial length of the motor housing and the motor end plate) compared to conventional motor designs. In the same or a different example, having the first winding portion at least partially axially overlap the second support bearing shortens the axial length of the motor system.

### SUMMARY OF THE DRAWINGS

FIG. 1 is a schematic, cross-sectional view of an embodiment of the invention including a brush holder, wherein for clarity, most of the hatch lines on the brush holder have been omitted and each of the two elongated electrical conductors of the brush holder is shown as a single line; and

FIG. 2 is view of the brush holder of FIG. 1 taken along lines 2-2 of FIG. 1.

### DETAILED DESCRIPTION

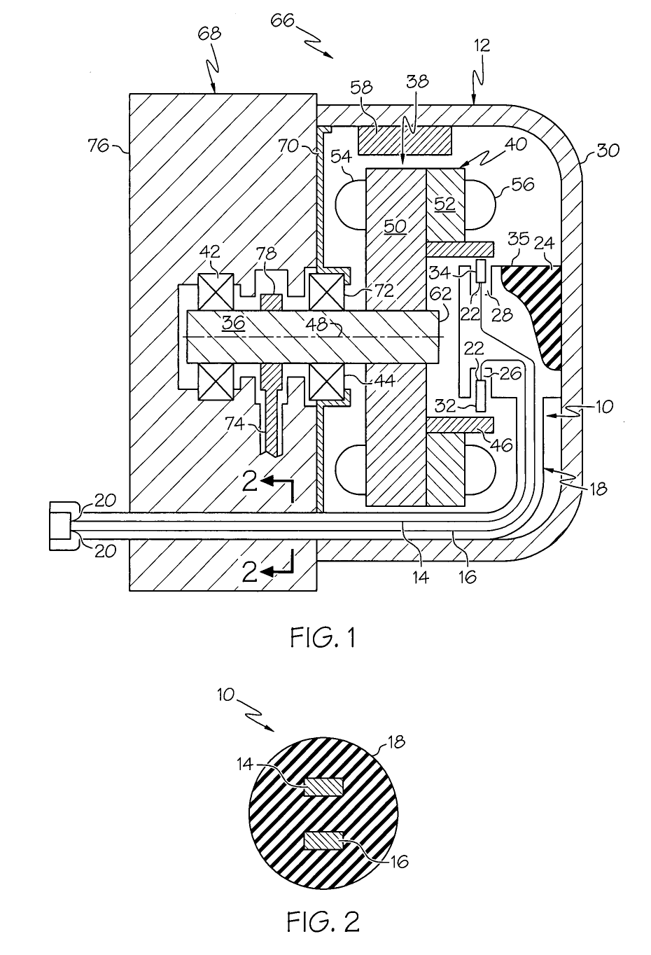

Referring now to the drawing, FIGS. 1-2 show an embodiment of the present invention. A first expression of the embodiment of FIGS. 1-2 is for a brush holder 10 for a DC motor 12 wherein the brush holder 10 includes flexible first and second elongated electrical conductors 14 and 16 and includes an elongated, flexible, electrically-insulative brush-holder body 18. The first and second elongated electrical conductors 14 and 16 each have a proximal end 20 and a distal end 22. The brush-holder body 18: separately surrounds, and is strip-molded to, the first and second elongated electrical conductors 14 and 16; extends from at least proximate the proximal end 20 to past the distal end 22 of each of the first and second elongated electrical conductors 14 and 16; and has a distal end portion 24 which surrounds the distal ends 22 of the first and second elongated electrical conductors 14 and 16 and which includes first and second brush recesses 26 and 28.

In one enablement of the first expression of the embodiment of FIGS. 1-2, the distal end portion 24 of the brush holder body 18 is adapted for attachment to a motor housing 30 of the DC motor 12. In the same or a different enablement, the first brush recess 26 is adapted to receive a first brush 32 electrically connected to the distal end 22 of the first elongated conductor 14, and the second brush recess 28 is adapted to receive a second brush 34 electrically connected (such as via a shunt 33) to the distal end 22 of the second elongated conductor 16. In the same or a different enablement, the distal end portion 24 has an outer surface 35, wherein the first brush recess 26 and the second brush recess 28 each open to the outer surface 35. In one variation, not shown, a first spring biases the first brush and a second spring biases the second brush into making contact with a commutator.

In one choice of materials of the first expression of the embodiment of FIGS. 1-2, the first and second elongated electrical conductors 14 and 16 consist essentially of brass or copper, and the brush-holder body 18 consists essentially of a synthetic resin.

A second expression of the embodiment of FIGS. 1-2 is for a DC motor 12 including a rotatable armature shaft 36, an armature core 38, an armature winding 40, first and second support bearings 42 and 44, and a commutator 46 and a brush holder 10. The armature shaft 36 has a central longitudinal axis 48. The armature core 38 has a first core portion 50 attached to the armature shaft 36 and has a second core portion 52 which is attached to the first core portion 50, which extends axially from the first core portion 50, and which is spaced radially outwardly apart from the armature shaft 36. The armature winding 40 is attached to the first and second core portions 50 and 52, has a first winding portion 54 extending axially beyond the first core portion 50, and has a second winding portion 56 extending axially beyond the second core portion 52. The first and second support bearings 42 and 44 are operatively connected to the armature shaft 36. The second support bearing 44 is disposed between the first support bearing 42 and the first core portion 50. The first winding portion 54 at least partially axially overlaps the second support bearing 44. The second winding portion 56 at least partially axially overlaps the commutator 46 and the brush holder 10.

In one construction of the embodiment of FIGS. 1-2, the first core portion 50 is a first lamination stack and the second core portion 52 is a second lamination stack. In one modification, each lamination stack is a self-locking lamination stack with a dimple of one layer being disposed in a corresponding recess of an adjacent layer. In one variation, first and second permanent magnets (only the first magnet 58 is shown; the second magnet is hidden by the brush-holder body 18) are radially spaced apart from the armature core 38 and are attached to the motor housing 30.

In one enablement of the second expression of the embodiment of FIGS. 1-2, the armature shaft 36 has a shaft end 62, wherein the first core portion 50 is attached to the armature shaft 36 proximate the shaft end 62, and wherein the second core portion 52 extends axially past the shaft end 62. In one variation, the commutator 46 is attached to the armature core 38 and disposed radially inward of the second core portion 52. In one modification, the brush holder 10 is non-rotatable and is disposed radially inward of the commutator 46. In one example, the DC motor 12 also includes a brush 32 (also called a first brush) disposed in the brush holder 10, wherein the second winding portion 56 at least partially axially overlaps the brush 32 (also called a first brush). It is noted that the previously-described first expression of the embodiment of FIGS. 1-2 (i.e., the brush holder 10) and the enablements thereof are equally applicable to the second expression of the embodiment of FIGS. 1-2.

A third expression of the embodiment of FIGS. 1-2 is for a motor system 66 including a DC motor 12 and an assembly 68. The DC motor 12 includes: a motor housing 30; a rotatable armature shaft 36; an armature core 38 attached to the armature shaft 36 and disposed within the motor housing 30; a motor end plate 70 having a central opening 72 and covering the motor housing 30, wherein the armature shaft 36 extends from the central opening 72; and a motor-associated support bearing 44 (also known as the second support bearing) operatively attached to the motor end plate 70 and to the armature shaft 36. The assembly 68 includes: a component (such as, but not limited to, a pump piston 74, only a portion of which is shown) operatively driven by the motor 12; an assembly housing 76; and an assembly-associated support bearing 42 (also known as the first support bearing) operatively attached to the assembly housing 76 and to the armature shaft 36.

In one enablement of the third expression of the embodiment of FIGS. 1-2, the assembly 68 is a vehicle anti-lock braking system hydraulic control unit, and the component is a pump piston 74. In one variation, the assembly includes a cam 78 attached to the armature shaft 36 between the assembly-associated support bearing 42 and the motor-associated support bearing 44, and wherein the cam 78 engages the pump piston 74.

Several benefits and advantages are derived from one or more of the expressions of an embodiment of the invention. In one example, the strip-molded brush holder avoids the manufacturing complexities of conventional metallic brush holders. In the same or a different example, having the second winding portion at least partially axially overlap the commutator and the brush holder and having the two support bearings located on the other side of the armature core shortens the axial length of the DC motor (the combined axial length of the motor housing and the motor end plate) compared to conventional motor designs. In the same or a different example, having the first winding portion at least partially axially overlap the second support bearing shortens the axial length of the motor system.

The foregoing description of several expressions of an embodiment of the invention has been presented for purposes of illustration. It is not intended to be exhaustive or to limit the invention to the precise form disclosed, and obviously many modifications and variations are possible in light of the above teaching. It is intended that the scope of the invention be defined by the claims appended hereto.

1. A brush holder for a DC motor comprising:
a) flexible first and second elongated electrical conductors each having a proximal end and a distal end; and
b) an elongated, flexible, electrically-insulative brush-holder body, wherein the brush-holder body: separately surrounds, and is strip-molded to, the first and second elongated electrical conductors; extends from at least proximate the proximal end to past the distal end of each of the first and second elongated electrical conductors; and has a distal end portion which surrounds the distal ends of the first and second elongated electrical conductors and which includes first and second brush recesses.

2. The brush holder of claim 1, wherein the distal end portion of the brush holder body is adapted for attachment to a motor housing of the DC motor.

3. The brush holder of claim 2, wherein the first brush recess is adapted to receive a first brush electrically connected to the distal end of the first elongated conductor, and wherein the second brush recess is adapted to receive a second brush electrically connected to the distal end of the second elongated conductor.

4. The brush holder of claim 3, wherein the distal end portion has an outer surface, and wherein the first brush recess and the second brush recess each open to the outer surface.

5. The brush holder of claim 2, wherein the distal end portion has an outer surface, and wherein the first brush recess and the second brush recess each open to the outer surface.

6. The brush holder of claim 1, wherein the first brush recess is adapted to receive a first brush electrically connected to the distal end of the first elongated conductor, and wherein the second brush recess is adapted to receive a second brush electrically connected to the distal end of the second elongated conductor.

7. The brush holder of claim 6, wherein the distal end portion has an outer surface, and wherein the first brush recess and the second brush recess each open to the outer surface.

8. The brush holder of claim 1, wherein the distal end portion has an outer surface, and wherein the first brush recess and the second brush recess each open to the outer surface.

9. A DC motor comprising:
a) a rotatable armature shaft having a central longitudinal axis;
b) an armature core having a first core portion attached to the armature shaft and having a second core portion which is attached to the first core portion, which extends axially from the first core portion, and which is spaced radially outwardly apart from the armature shaft;
c) an armature winding attached to the first and second core portions, having a first winding portion extending axially beyond the first core portion, and having a second winding portion extending axially beyond the second core portion;
d) first and second support bearings operatively connected to the armature shaft, wherein the second support bearing is disposed between the first support bearing and the first core portion and wherein the first winding portion at least partially axially overlaps the second support bearing; and
e) a commutator and a brush holder, wherein the second winding portion at least partially axially overlaps the commutator and the brush holder.

10. The DC motor of claim 9, wherein the armature shaft has a shaft end, wherein the first core portion is attached to the armature shaft proximate the shaft end, and wherein the second core portion extends axially past the shaft end.

11. The DC motor of claim 10, wherein the commutator is attached to the armature core and disposed radially inward of the second core portion.

12. The DC motor of claim 11, wherein the brush holder is non-rotatable and is disposed radially inward of the commutator;

13. The DC motor of claim 12, also including a brush disposed in the brush holder, wherein the second winding portion at least partially axially overlaps the brush.

14. The DC motor of claim 9, wherein the brush holder includes:
flexible first and second elongated electrical conductors each having a proximal end and a distal end; and
an elongated, flexible, electrically-insulative brush-holder body, wherein the brush-holder body: separately surrounds, and is strip-molded to, the first and second elongated electrical conductors; extends from at least proximate the proximal end to past the distal end of each of the first and second elongated electrical conductors; and has a distal end portion which surrounds the distal ends of the first and second elongated electrical conductors and which includes first and second brush recesses.

15. The DC motor of claim 14 wherein the distal end portion of the brush holder body is adapted for attachment to a motor housing of the DC motor.

16. The DC motor of claim 14, wherein the first brush recess is adapted to receive a first brush electrically connected to the distal end of the first elongated conductor, and wherein the second brush recess is adapted to receive a second brush electrically connected to the distal end of the second elongated conductor.

17. The DC motor of claim 16, wherein the first brush recess is aligned substantially parallel to an outwardly-extending radius from the armature shaft to receive a first brush, and wherein the second brush recess is aligned substantially parallel to the outwardly-extending radius from the armature shaft to receive a second brush.

18. A motor system comprising:
a) a DC motor including:
(1) a motor housing,
(2) a rotatable armature shaft,
(3) an armature core attached to the armature shaft and disposed within the motor housing,
(4) a motor end plate having a central opening and covering the motor housing, wherein the armature shaft extends from the central opening, and
(5) a motor-associated support bearing operatively attached to the motor end plate and to the armature shaft; and
b) an assembly including:
(1) a component operatively driven by the motor:
(1) an assembly housing, and
(2) an assembly-associated support bearing operatively attached to the assembly housing and to the armature shaft.

19. The assembly of claim 18, wherein the assembly is a vehicle anti-lock braking system hydraulic control unit, and wherein the component is a pump piston.

20. The assembly of claim 19, wherein the assembly includes a cam attached to the armature shaft between the assembly-associated support bearing and the motor-associated support bearing, and wherein the cam engages the pump piston.
